(19) United States
(12) Patent Application Publication
(10) Pub. No.: US 2010/0094845 A1
(43) Pub. Date: Apr. 15, 2010

(54) CONTENTS SEARCH APPARATUS AND METHOD

(76) Inventors: Jin Young Moon, Daejeon (KR); Jong Hoon Lee, Daejeon (KR); Eui Hyun Paik, Daejeon (KR); Kwang Roh Park, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/332,499

(22) Filed: Dec. 11, 2008

(30) Foreign Application Priority Data
Oct. 14, 2008 (KR) 10-2008-0100691

(51) Int. Cl. G06F 7/06; G06F 17/30

(52) U.S. Cl. 707/705; 707/E17.014

(57) ABSTRACT

Provided is a contents search apparatus and a method thereof. The contents search apparatus includes a query word preprocessing module expanding an inputted query word; and a search module searching for contents of a tag corresponding to the expanded query word. The contents search method includes expanding an inputted query word; and searching for contents tagged using a tag corresponding to the expanded query word.

### CROSS-REFERENCE TO RELATED APPLICATIONS

This application claims priority under 35 U.S.C. §119 to Korean Patent Application No. 10-2008-100691, filed on Oct. 14, 2008, the disclosure of which is incorporated herein by reference in its entirety.

### TECHNICAL FIELD

The present disclosure relates to a tag-based search, and in particular, to a contents search apparatus and method capable of increasing the quality of the search as well as ensuring a user's free tag input.

This work was supported by the IT R&D program of MIC/IITA [2008-F-043-01, Development of Technique for Social Media Service as Type of Recognition of Locational/Social Relation]

### BACKGROUND

Recently, the semantic web is attracting attention to enhance the efficiency of the search and application by adding metadata, which is semantic information in web mainly based on data such as a text, an image, a video, a blog etc.

A related art semantic web defines an ontology which is a system and a vocabulary to be used, and describes metadata through a semantic annotation using the ontology. However, the semantic annotation technology based on the ontology has not been easily propagated due to technological difficulty and lack of user usability.

In order to make up for this point, a tagging technology focused on the user usability has emerged. In the tagging technology, a tagging person may select a vocabulary. The related art tagging technology has a convenience of freely describing metadata, but has the following limitations in applying tags to the search etc.

First, metadata may be described in different levels because the related art tagging technology does not follow a unified classification system. Accordingly, the meaning of metadata may be obscured by synonyms or multi-sense words of the inputted tag.

Second, the related art tagging technology allows that a user define the identical meaning by different parts of speech such as a verb, a noun, and an adjective, or by a wrong spell. So, this may cause a problem at a time of search. Also, if an exact matching between a tag and an inputted query word is used, the contents having tagging information relevant to an inputted query word may not be searched.

In order to make up for this point, the related art tagging technology provides a spell check or a tag auto completion function at a time of the tag generation, recommends a tag of high frequency, or performs refining a tag of giving a meaning to the tag through dictionaries or thesauruses.

The refining tag may increase the quality of the search, but reduce a convenience at a time of input.

### SUMMARY

Accordingly, the present disclosure provides a contents search apparatus and method capable of enhancing the quality of search by expanding a query word using an inputted tag.

The present disclosure also provides a contents search apparatus and method capable of providing a convenience of a user input by recommending a query word corresponding with an inputted keyword.

According to an aspect, there is provided a contents search apparatus including: a query word preprocessing module expanding an inputted query word; and a search module searching for contents of a tag corresponding to the expanded query word.

According to another aspect, there is provided a contents search apparatus including: a query word preprocessing module expanding an inputted query word; a search module searching for contents tagged using a tag corresponding to the expanded query word; and a tag management module providing a recommendation query word for the contents search by analyzing tagging information of the inputted query word.

According to another embodiment, there is provided a contents search method including: expanding an inputted query word; and searching for contents tagged using a tag corresponding to the expanded query word.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram illustrating a contents search apparatus according to an exemplary embodiment.

FIG. 2 is a block diagram illustrating a contents search apparatus according to another exemplary embodiment.

FIG. 3 is a flowchart illustrating a query word preprocessing of a query word preprocessing module according to an exemplary embodiment.

FIG. 4 is a flowchart illustrating a query word expansion process of a query word preprocessing module according to an exemplary embodiment.

FIG. 5 is a flowchart illustrating a contents search process of a search module according to an exemplary embodiment.

FIG. 6 is a flowchart illustrating a query word recommendation process of a tag management module according to another exemplary embodiment.

### DETAILED DESCRIPTION OF EMBODIMENTS

Hereinafter, specific embodiments will be described in detail with reference to the accompanying drawings.

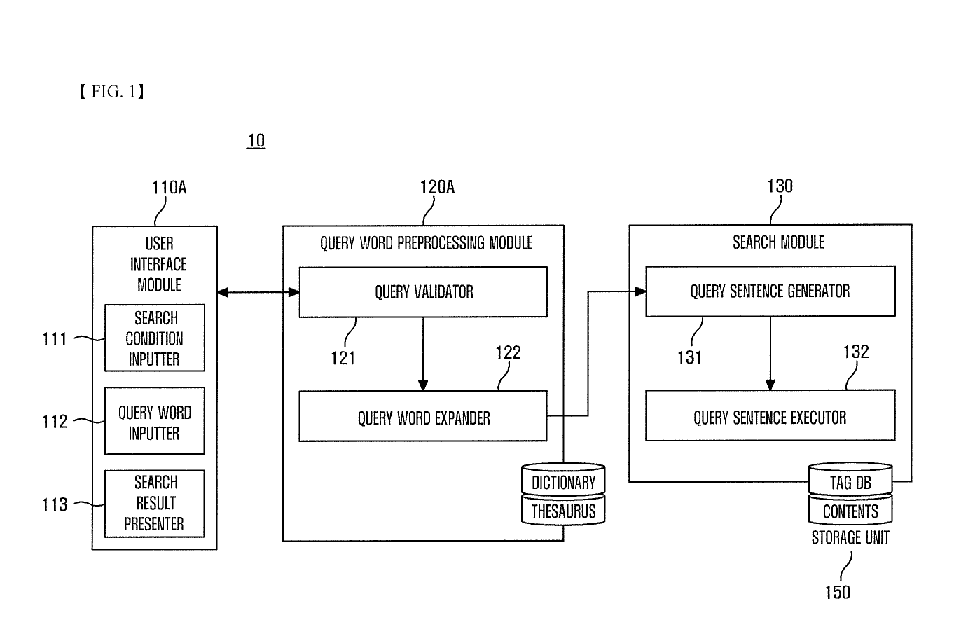

FIG. 1 is a block diagram illustrating a contents search apparatus 10 according to an exemplary embodiment.

Referring to FIG. 1, a contents search apparatus 10 according to an exemplary embodiment includes a user interface module 110a, a query word preprocessing module 120a, and a search module 130.

The user interface module 110a provides a user interface for a query word input such as keyword etc, a contents search request, a search condition input, etc.

The user interface module 110a includes a search condition inputter 111, a query word inputter 112, and a search result presenter 113.

The search condition inputter 111 provides a menu about at least one of a generation time and an upload time of contents to be search, a document format, a provider, fee information, and whether or not a query word recommendation function is used, and receives a menu selection from a user. Also, the search condition inputter 111 receives whether to accept a recommendation on query word using a tag relevant to an inputted search query word. In this case, the search condition inputter 111 as a factor limiting the search range of the contents may be omitted according to user's selection.

In other case, the search condition inputter 111 may be omitted when an input of the search condition is unnecessary because the user desires only a basic search result.

The query word inputter 112 receives a query word such as keyword used in the contents search from the user.

The search result presenter 113 presents the contents searched by the search module 130 to the user.

The query word preprocessing module 120a selects a valid query word from the inputted query words, expands the valid query word with reference to a dictionary, a thesaurus etc., and delivers the valid query word to the search module 130 together with the inputted search condition

The query word preprocessing module 120a includes a query validator 121 and a query word expander 122.

The query validator 121 checks whether the inputted query word is valid, and delivers the query word to the query word expander 122 if the query word is valid. For example, the query validator 121 may determine whether the query word is valid by checking spell of the query word through the dictionary, or the thesaurus or a web dictionary.

Meanwhile, if the query word is not valid, the query validator 121 may deliver the query word to the search module 130 without expanding the query word.

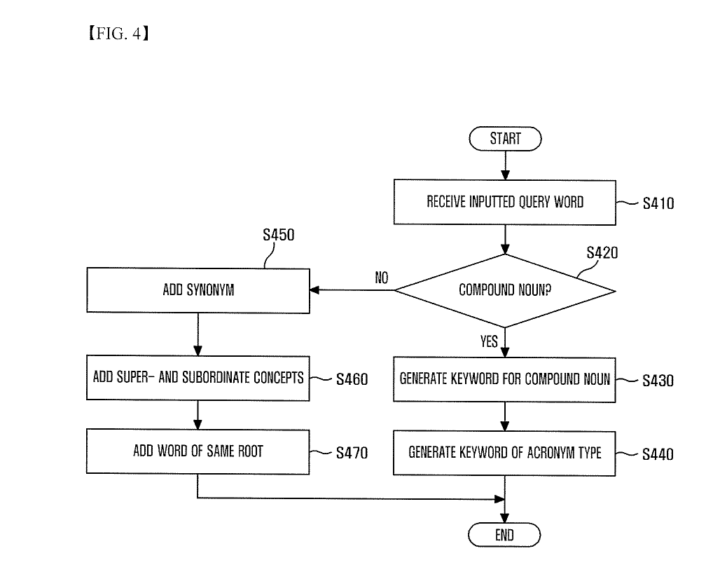

The query word expander 122 expands the valid query word according to the result of the determination of the query validator 121. More particularly, the query word expander 122 may expand the query word by using at least one of a part of speech, an acronym, a new-coined word, a superordinate word, a subordinate word, a synonym, and a root of a word. If the inputted query word is a compound noun, the query word expander 122 may expand the inputted query word by ignoring a spacing between words or adding a special character such as a hyphen. That is, the query word expander 122 preprocesses and expands the inputted query word so as to raise the quality of contents search result. In this case, details of the above procedure will be described below with reference to FIG. 4.

The search module 130 receives the expanded query word and the search condition from query word preprocessing module 120a, and searches for contents of a tag in a storage unit 150 corresponding to the expanded query word and the search condition.

The search module 130 includes a query sentence generator 131 and a query sentence executor 132.

The query sentence generator 131 generates a query sentence corresponding to the expanded query word and the received search condition. Here, the query sentence may be generated by transforming the expanded query word and the received search condition into a query language (e.g., Structured Query Language (SQL)), which is used in a DataBase Management System (DBMS) including the storage unit 150 including database relevant to a tag and contents.

The query sentence executor 132 searches the storage unit 150 for the contents or tagged contents corresponding to the query sentence, and provides the tagged contents to the user through the user interface module 110a.

The contents search apparatus 10 further may include the storage unit 150 including the database of the contents to be searched and the related tags.

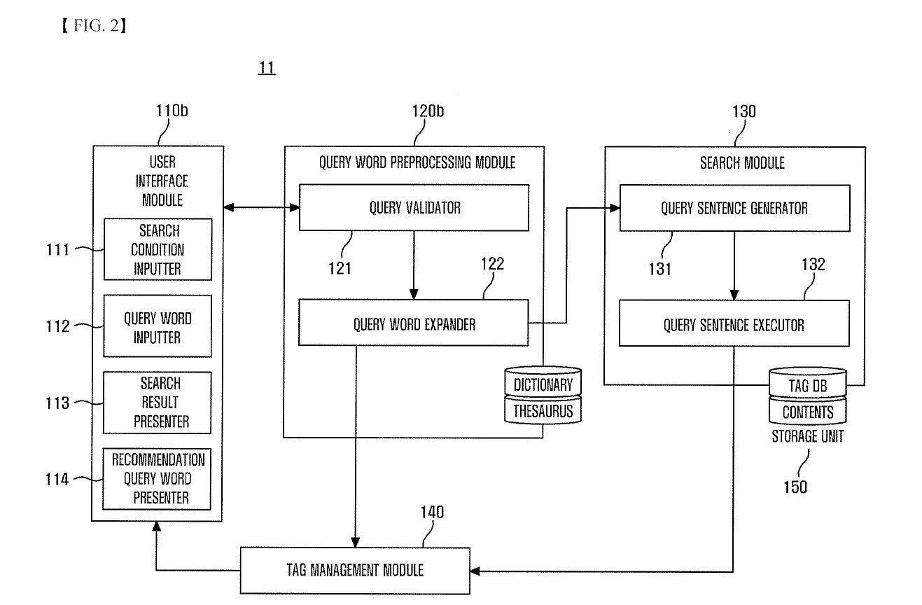

Hereinafter, a contents search apparatus 11 according to another exemplary embodiment will be described with reference to FIG. 2. FIG. 2 is a block diagram illustrating a contents search apparatus 11 according to an exemplary embodiment. The elements performing the same functions as those in FIG. 1 will be referred to by the same reference numerals, and details thereof will be omitted for the convenience of explanation.

Referring to FIG. 2, a contents search apparatus 11 according to another exemplary embodiment includes a user interface module 110b, a query word preprocessing module 120b, a search module 130, and a tag management module 140.

The user interface module 110b provides a user interface for a query word recommendation request besides a query word input such as keyword etc, a contents search request and a search condition input.

In this case, the user interface module 110a further includes a recommendation query word presenter 114 besides the search condition inputter 111, the query word inputter 112 and the search result presenter 113.

The recommendation query word presentation 114 provides the recommendation query word searched by a tag management module 140 to a user.

When receiving the query word recommendation request from the search condition inputter 111 of the user interface module 110b, the query validator 121 of the query word preprocessing module 120b may request the tag management module 140 to recommend a query word, receive the query word recommended by tag management module 140, and expand the query word using the recommended query word.

Also, the tag management module 140 may receive a query recommendation command and a keyword, search for a related query word using tagging information of the keyword, and provide a recommendation query word having a high relation among the related query word to the user. In this case, the tag management module 140 may be omitted when the contents search apparatus 11 does not provide a query word recommendation function or receives recommendation function refusal of the user from the search condition inputter 111 of the user interface module 110b.

The tag management module 140, e.g., may determine degree of the relation by producing a co-occurrence distribution about the tag of the related query word. In this case, the tag management module 140 may determine the relation using not the simply co-occurrence distribution but other parameter (e.g., cosine similarity) produced from the simultaneous co-occurrence distribution.

The contents search apparatus 11 according to another exemplary embodiment may not only provide the convenience of the user input through the recommendation query word, but also enhance the quality of the contents search.

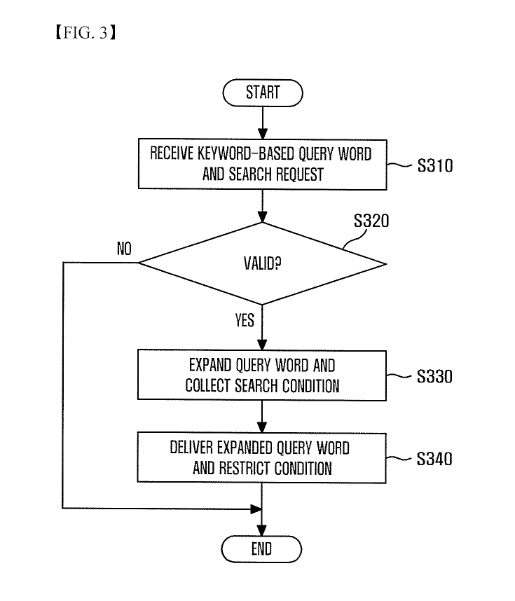

Hereinafter, a contents search method according to another exemplary embodiment will be described in detail with reference to FIGS. 3 to 6.

FIG. 3 is a flowchart illustrating a query word preprocessing of a query word preprocessing module 120b according to an exemplary embodiment.

Referring FIG. 3, in step S310, the query word preprocessing module 120b receives a keyword based query word from a user interface module 110b.

In step S320, the query word preprocessing module 120b checks and determines whether a query word is valid.

In this case, the query word preprocessing module 120b may check the spell of the query word, or determine whether the inputted query word is valid through dictionaries. That is, it is determined whether the query word is valid by comparing the received query word with words of a dictionary, a thesaurus, or a web-based dictionary.

In step S330, if the query word preprocessing module 120b expands the query word if the received query word is valid.

In step S340, the query word preprocessing module 120b transmits the expanded query word to the search module 130.

Thus, the query word preprocessing module 120b can enhance the effectiveness of the contents search by expanding the query word to a level capable of satisfying the intention of the user without the intervention of the user. When the received query word is not valid, the query word preprocessing module 120b may deliver the receive query word to the search module 130 as it is, and allow the search module 130 to search for contents of a tag corresponding to the received query word.

Hereinafter, a query word expansion method of the query word preprocessing module 120b as briefly described in the step S330 will be described in detail with reference to FIG. 4. FIG. 4 is a flowchart illustrating a query word expansion process of a query word preprocessing module 120b according to an exemplary embodiment.

Referring FIG. 4, in step S410, the query word preprocessing module 120b receives a query word and check whether the query word is valid. If the query word is valid, the following steps are performed.

In step S420, the query word preprocessing module 120b verifies whether the valid query word is a compound noun. If the valid query word includes a combination of independent nouns existing in dictionaries, the query word preprocessing module 120b recognizes the valid query word as the compound noun.

In step 430, if the query word is the compound noun, the query word preprocessing module 120b generates a tag-typed keyword for the compound noun by adding special characters such as “_”, “-”, “.” “*” between the independent nouns. For example, if a compound noun “opensource” is inputted as a query word, the query word preprocessing module 120b generates keywords such as “open source”, “open-source”, “open.source” and “open*source”. The tag for the compound noun may be generated as described above because a space between words of the compound words means different tag. Thus, the query word preprocessing module 120b may transform the form of the tag so as to mean an actual query word, by expanding the query word including tags generated without spaces and using the special characters.

In step S440, the query word preprocessing module 120b adds an acronym-typed keyword to express the compound noun. For example, when “New York” is inputted, the query word preprocessing module 120b may add N.Y. as a keyword, which is an acronym for “New York”.

On the other hand, in step S450, the query word preprocessing module 120b checks and adds a synonym from dictionaries and thesaurus when the query word is not a compound noun.

In step S460, the query word preprocessing module 120b checks and adds a superordinate concept and a subordinate concept of the query word from form the dictionaries and the thesaurus.

In step S470, the query word preprocessing module 120b searches for different part of speech pertaining to the same word root as the query word with reference to the dictionaries and the thesaurus, and searches for and adds a new-coined word through a web-based dictionary. For example, if a noun “fun” is inputted as a query word, the query word preprocessing module 120b adds an adjective “funny” transformed from the noun.

After that, the query word preprocessing module 120b expands the query word by synthesizing details generated and added according to the steps S420 to S470. In this case, the query word preprocessing module 120b may limit an expansion range of the query word so as to perform only the desired steps among the steps S430 to S470 according to a user's selection.

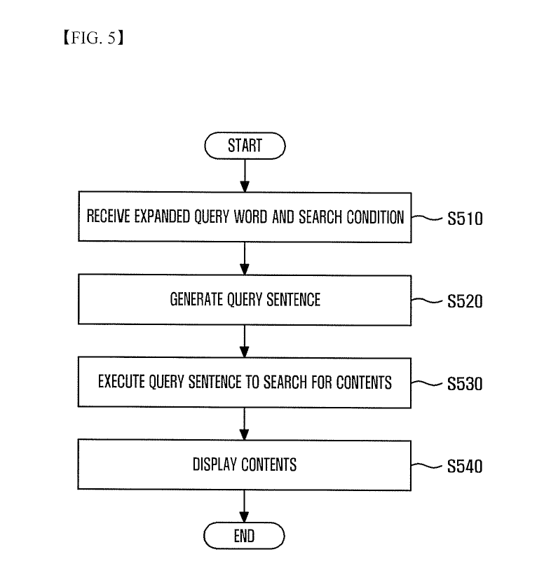

Hereinafter, a method of searching for contents using the expanded query word and a search condition by a search module 130 will be described with reference to FIG. 5.

FIG. 5 is a flowchart illustrating a contents search process of a search module 130 according to an exemplary embodiment.

In step S510, the search module 130 receives the expanded query word and the search condition from the query word preprocessing module 120b.

In step S520, the search module 130 generates a query sentence corresponding to the expanded query word and the search condition. The search module 130 generates the query sentence by transforming the expanded query word and the search condition into a query language (e.g., SQL) used in DBMS

In step S530, the search module 130 executes the generated query sentence to search for contents tagged with a tag corresponding to the expanded query word satisfying the search condition.

In step S540, the search module 130 provides the searched contents to the user through the user interface module 110b. In this case, if multiple contents exist, the search module 130 displays the contents sorted by at least one of generation time, popularity, and social relation of the tagged contents to the user through the user interface module 110b.

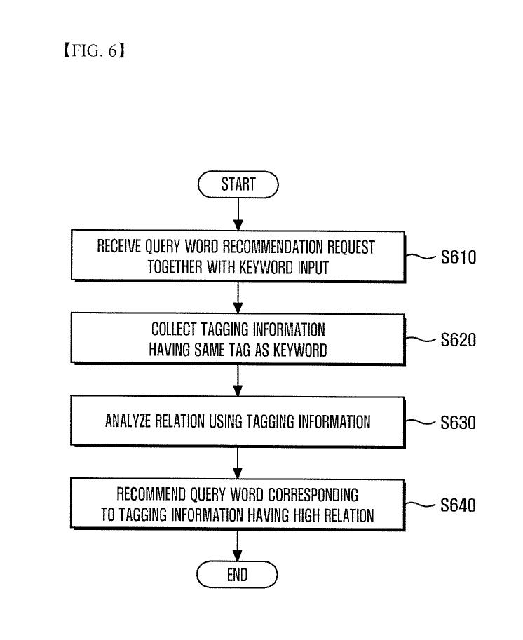

Hereinafter, a method of recommending the query word by a tag management module 140 is described in detail with reference to FIG. 6.

FIG. 6 is a flowchart illustrating a query word recommendation process of a tag management module 140 according to another exemplary embodiment.

In step S610, the tag management module 140 receives a recommendation query word request and a keyword inputted from the query word inputter 112.

In step S620, the tag management module 140 collects tagging information having a tag relevant to the keyword. In this case, the collected tagging information may include a tagging person, a tagged hour, a collection of the tags used in the tagging, and a frequency of each tag' use.

In step S630, the tag management module 140 analyzes a relation between the tagging information. For example, the tag management module 140 may analyze the relation by the similarity measure such as the cosine similarity calculated from the co-occurrence distribution between the tags.

In step S640, the tag management module 140 recommends the recommendation query word corresponding to tagging information having high relation among the collected tagging information to the user through the recommendation query word presentation 114.

Then, the user may select and apply the recommendation query word which is expected to be useful for search, thereby enhancing the quality of the search.

According to exemplary embodiments, it is possible to enhance the quality of the search result of contents by expanding the query word as well as providing the convenience of the input.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A contents search apparatus comprising:
a query word preprocessing module expanding an inputted query word; and
a search module searching for contents of a tag corresponding to the expanded query word.

2. The contents search apparatus of claim 1, further comprising a tag management module providing a recommendation query word by analyzing a tag relevant to the inputted query word.

3. The contents search apparatus of claim 1, wherein the query word preprocessing module checks whether the query word is valid, and expands the query word if the query word is valid.

4. The contents search apparatus of claim 1, wherein, when the inputted query word is invalid, the query word preprocessing module delivers the inputted query word to the search module without the expanding of the query word, the search module searching for content of a tag corresponding to the delivered query word.

5. The contents search apparatus of claim 1, wherein the query word preprocessing module expands the query word using at least one of a part of speech, a new-coined word, a superordinate word, a subordinate word, and a synonym of the query word when the inputted query word is not a compound noun.

6. The contents search apparatus of claim 1, wherein, when the inputted query word is a compound noun, the query word preprocessing module expands the query word by generating a tag for the compound noun using a special character, or by adding an acronym corresponding to the compound noun.

7. The contents search apparatus of claim 1, further comprising a search condition inputter providing a search condition for the contents, and delivering a user's selection for the provided search condition to the query word preprocessing module or the search module,
wherein the query word preprocessing module or the search module uses the selected search condition at a time of search.

8. The contents search apparatus of claim 7, wherein the search condition comprises at least one of a generation time and an upload time of desired contents, a document format, a provider, fee information, and whether or not a query word recommendation function is used.

9. The contents search apparatus of claim 7, wherein the search module comprises:
a query sentence generator generating a query sentence corresponding to the expanded query word and the search condition; and
a query sentence executor searching for contents tagged using the query sentence.

10. A contents search apparatus comprising:
a query word preprocessing module expanding an inputted query word;
a search module searching for contents tagged using a tag corresponding to the expanded query word; and
a tag management module providing a recommendation query word for the contents search by analyzing tagging information of the inputted query word.

11. The contents search apparatus of claim 10, wherein the query word preprocessing module comprises:
a query validator checking if the inputted query word is valid; and
a query word expander expanding a valid query word according to a result of the checking.

12. The contents search apparatus of claim 11, wherein, when the inputted query word is invalid, the query word preprocessing module delivers the query word to the search module without the expanding of the query word, the search module searching for content of a tag corresponding to the delivered query word.

13. The contents search apparatus of claim 10, wherein the query word preprocessing module expands the query word using at least one of a part of speech, a new-coined word, a superordinate word, a subordinate word, and a synonym of the query word when the inputted query word is not a compound noun.

14. The contents search apparatus of claim 10, further comprising:
a user interface module providing a user interface comprising the query word input; and
a storage unit having at least one of the contents and the contents of the tag.

15. A contents search method comprising:
expanding an inputted query word; and
searching for contents tagged using a tag corresponding to the expanded query word.

16. The contents search method of claim 15, wherein the expanding of the inputted query word comprises:
checking if the inputted query word is valid; and
expanding the query word if a result of the checking is valid.

17. The contents search method of claim 16, further comprising recommending a valid query word using a related tag if a query word recommendation is requested.

18. The contents search method of claim 15, wherein the expanding of the inputted query word comprises using at least one of a part of speech, a new-coined word, a superordinate word, a subordinate word, a synonym and a word root of the query word, and a tag generated for a compound noun.

19. The contents search method of claim 15, wherein the searching for contents comprises:
sorting the searched contents by a predetermined order; and
displaying the contents of the tag in the sorted order.

20. The contents search method of claim 15, further comprising:
receiving a keyword and a command of requesting a query word recommendation;
searching for a recommendation query word corresponding to tagging information of the keyword; and
displaying the searched recommendation query word.
